(19) United States
(12) Patent Application Publication
(10) Pub. No.: US 2008/0090633 A1
(43) Pub. Date: Apr. 17, 2008

(54) GAMING SYSTEM AND A METHOD OF GAMING

(76) Inventor: Paul Francis Jason Bramble, Rosebery NSW (AU)

Correspondence Address: MCANDREWS HELD & MALLOY, LTD, 500 WEST MADISON STREET, SUITE 3400, CHICAGO, IL, 60661, US

(21) Appl. No.: 11/852,840

(22) Filed: Sep. 10, 2007

(30) Foreign Application Priority Data
Sep. 11, 2006 (AU) 2007904955
Feb. 9, 2007 (AU) 2006900652

(51) Int. Cl. G06F 19/00; A63F 13/00; A63F 9/24

(52) U.S. Cl. 463/17

(57) ABSTRACT

A gaming system is disclosed which comprises a bet receiver arranged to receive a bet amount from a player, a symbol modifier arranged to modify at least one symbol in a set of symbols when the bet amount is greater than a minimum bet amount so as to increase the probability of occurrence of a symbol win combination and thereby maintain the Mean Prize Value for the symbol win combination greater than or equal to a predetermined minimum Mean Prize Value. The system also comprises a symbol selector arranged to randomly select a plurality of symbols from the set of symbols for display to a player, a game outcome generator arranged to determine a game outcome based on the selected symbols, and a prize allocator arranged to allocate a prize amount to the player based on the determined game outcome. A corresponding method of gaming is also disclosed.

### CROSS REFERENCE TO RELATED APPLICATIONS

This application claims priority to Australian Patent Application No. AU2006904955, having an international filing date of Sep. 11, 2006, and Australian Patent Application No. AU2007900652, having an international filing date of Feb. 9, 2007, which are hereby incorporated by reference herein in their entirety.

### FIELD OF THE INVENTION

The present invention relates to a gaming system and to a method of gaming.

### BACKGROUND OF THE INVENTION

It is known to provide a gaming system which comprises a game controller arranged to randomly display several symbols from a predetermined set of symbols and to determine a game outcome such as a game win based on the displayed symbols. Such gaming systems may commonly be implemented as a stepper machine having a plurality of reels with each reel carrying several symbols of the set, or a video machine wherein selected symbols are displayed on virtual reels on a graphical display device. Win outcomes can occur based on symbols appearing in one or more horizontal lines nominated by a player, or in any other predetermined way.

In at least some jurisdictions, in order to comply with gaming regulations it is necessary to ensure that a player is not disadvantaged in a wagering game by increasing a bet amount.

A measure of whether a player is disadvantaged in a wagering game can be obtained by calculating the Mean Prize Value of a win outcome to the player. The Mean Prize Value for a particular win outcome is defined as:
Mean Prize Value=Prize amount for the win outcome/Expected amount spent to win the prize

This can also be expressed as:
Mean Prize Value=Prize amount/[(Amount bet per line)/(Win probability)]

In conventional gaming systems, when the bet amount per line is increased by a player, the prize amount is also increased by an amount such that the Mean Prize Value for each win outcome is maintained at least at a value equal to the Mean Prize Value corresponding to a minimum bet amount.

In some circumstances, it is desirable or necessary to limit the maximum prize amount. For example, in some jurisdictions, a maximum limit is imposed on the prize amount and, as a consequence, for some win outcomes it is not possible to multiply the prize amount in order to maintain the Mean Prize Value above a predetermined minimum Mean Prize Value because multiplication of the prize amount will exceed the maximum permissible prize amount.

### SUMMARY OF THE INVENTION

In accordance with a first aspect of the present invention, there is provided a gaming system comprising:

a bet receiver arranged to receive a bet amount from a player;

a symbol modifier arranged to modify at least one symbol in a set of symbols when the bet amount is greater than a minimum bet amount so as to increase the probability of occurrence of a symbol win combination and thereby maintain the Mean Prize Value for the symbol win combination greater than or equal to a predetermined minimum Mean Prize Value;

a symbol selector arranged to randomly select a plurality of symbols from the set of symbols for display to a player;

a game outcome generator arranged to determine a game outcome based on the selected symbols; and,

a prize allocator arranged to allocate a prize amount to the player based on the determined game outcome.

In one arrangement, the symbol modifier is arranged to modify at least one symbol in the set of symbols when the bet amount is greater than a minimum bet amount if increasing the prize amount sufficiently to increase the Mean Prize Value to a value greater than or equal to a predetermined minimum Mean Prize Value would produce a prize amount which exceeds a maximum permissible prize amount.

In one arrangement, the set of symbols comprises a set of special symbols comprising a first set of first special symbols and a second set of second special symbols.

The first and second sets of symbols may share a common property and may include a distinguishable different property, and the symbol modifier may be arranged to replace at least one second symbol with at least one respective first symbol when the bet amount is above the minimum bet amount in order to maintain the Mean Prize Value associated with the first set of symbols greater than or equal to a predetermined minimum Mean Prize Value. The common property may be symbol type such as a car or a dog and the distinguishable property may be symbol colour.

In one embodiment, the game outcome generator is arranged such that a win outcome may occur based on a combination of the first and second sets of symbols.

In one embodiment, the set of special symbols comprises a relatively low number of first special symbols and a relatively high number of second special symbols, and the prize allocator is arranged to allocate a relatively high prize amount to a win symbol combination including the first set of special symbols and a relatively low prize amount to a win symbol combination including the second set of special symbols.

In one arrangement, the system is arranged to increase the prize amount associated with a symbol win combination so that the Mean Prize Value for the win symbol combination is greater than or equal to a predetermined minimum Mean Prize Value when the bet amount is greater than the minimum bet amount if increasing the prize amount sufficiently to increase the Mean Prize Value to a value greater than or equal to a predetermined minimum Mean Prize Value would not produce a prize amount which exceeds a maximum permissible prize amount.

In one embodiment, the gaming system is arranged to apply a formula to calculate the required probabilities for occurrence of symbols on each reel based on the desired win outcome probability, and to modify the number of symbols on one or more reels based on the calculated probabilities.

The formula may be derived by specifying desired outcome probabilities associated with symbols, specifying a relationship between the respective probabilities of symbols occurring on a plurality of reels, and calculating the probability of a symbol occurring on each reel using the relationship and the specified outcome probabilities.

In one arrangement, the relationship between the probability of symbols occurring on a plurality of reels is that the probability of a symbol occurring on each reel of a plurality of reels is the same.

In one embodiment, the gaming system comprises 5 reels and the formula for calculating the required probabilities for occurrence of symbols on each reel is:
u=v=w=(nA+nB+nC)^{1/3} (1)
x=(B+C)/(A+B+C) (2)
y=C/(B+C) (3)
where u, v, w, x and y are the probabilities of occurrence of a symbol on reels 1, 2, 3, 4 and 5 respectively; n is the number of credits bet; and A, B and C are desired outcome probabilities for win outcomes associated with predetermined combinations of symbols.

The gaming system may be implemented as a stand alone gaming machine or across a network.

In accordance with a second aspect of the present invention, there is provided a method of gaming comprising:

providing a set of symbols

receiving a bet amount from a player;

modifying at least one symbol in a set of symbols when the bet amount is greater than a minimum bet amount so as to increase the probability of occurrence of a symbol win combination and thereby maintain the Mean Prize Value for the symbol win combination greater than or equal to a predetermined minimum Mean Prize Value;

randomly selecting a plurality of symbols from the set of symbols for display to a player;

determining a game outcome based on the selected symbols; and

allocating a prize amount to the player based on the determined game outcome.

In accordance with a third aspect of the present invention, there is provided a computer program arranged when loaded into a computer to instruct the computer to operate in accordance with a gaming system comprising:

a bet receiver arranged to receive a bet amount from a player;

a symbol modifier arranged to modify at least one symbol in a set of symbols when the bet amount is greater than a minimum bet amount so as to increase the probability of occurrence of a symbol win combination and thereby maintain the Mean Prize Value for the symbol win combination greater than or equal to a predetermined minimum Mean Prize Value;

a symbol selector arranged to randomly select a plurality of symbols from the set of symbols for display to a player;

a game outcome generator arranged to determine a game outcome based on the selected symbols; and,

a prize allocator arranged to allocate a prize amount to the player based on the determined game outcome.

In accordance with a forth aspect of the present invention, there is provided a computer usable medium having computer readable program code embodied therein for causing a computer to operate in accordance with a gaming system comprising:

a bet receiver arranged to receive a bet amount from a player;

a symbol modifier arranged to modify at least one symbol in a set of symbols when the bet amount is greater than a minimum bet amount so as to increase the probability of occurrence of a symbol win combination and thereby maintain the Mean Prize Value for the symbol win combination greater than or equal to a predetermined minimum Mean Prize Value;

a symbol selector arranged to randomly select a plurality of symbols from the set of symbols for display to a player;

a game outcome generator arranged to determine a game outcome based on the selected symbols; and,

a prize allocator arranged to allocate a prize amount to the player based on the determined game outcome.

### BRIEF DESCRIPTION OF THE DRAWINGS

The present invention will now be described, by way of example only, with reference to the accompanying drawings, in which:

FIG. 1 is a diagrammatic block diagram of a gaming system in accordance with an embodiment of the present invention;

FIG. 2 is a diagrammatic representation of a gaming system in accordance with an embodiment of the present invention with the gaming system implemented in the form of a stand alone gaming machine;

FIG. 3 is a schematic block diagram of operative components of the gaming machine shown in FIG. 2;

FIG. 4 is a schematic block diagram of components of a memory of the gaming machine shown in FIG. 2;

FIG. 5 is a schematic diagram of a gaming system in accordance with an alternative embodiment of the present invention with the gaming system implemented over a network; and

FIG. 6 is a flow diagram illustrating game play of a gaming system in accordance with an embodiment of the present invention.

### DESCRIPTION OF AN EMBODIMENT OF THE INVENTION

Referring to the drawings, there is shown a gaming system arranged to implement a probabilistic wagering game of the type wherein a player wagers a bet amount, several symbols from a set of symbols are randomly displayed, and a game outcome including whether a prize amount is payable is determined on the basis of the displayed symbols. With some such probabilistic wagering games, the set of symbols include standard symbols and function symbols, and the game outcome is determined on the basis of the displayed standard symbols and the function associated with any displayed function symbol. For example, standard symbols may resemble fruit such as apples, pears and bananas with a win outcome being determined when a predetermined number of the same fruit appear on a display in the same line, scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

The present gaming system operates such that the Mean Prize Value remains greater than or equal to a predetermined minimum Mean Prize Value for all win combinations and for all bet amounts. In this way, a player is not disadvantaged by increasing the bet amount.

This is achieved by increasing the prize amount for win outcomes having relatively small prize amounts, and by increasing the probability of winning a prize for win outcomes having prize amounts which are sufficiently large that the prize amount cannot be multiplied without exceeding the maximum permissible prize amount. The probability of winning a prize for a particular win outcome is increased by adding one or more symbols associated with the win outcome to one or more of the reels.

Modifying the symbols present on a reel may be achieved in several ways. For example, each reel may comprise a predetermined number of special symbols which include a predetermined number of a first set of special symbols and a predetermined number of a second set of special symbols. The first and second set of special symbols may share a common property and include a distinguishable different property, and the special symbols on one or more of the reels may be modified by changing the distinguishable property so as to modify the respective probabilities for win outcomes associated with the first and second sets of special symbols.

In one example, the special symbols are cars, the first set of special symbols are blue cars and the second set of special symbols are red cars. In order to modify the respective probabilities for win outcomes including blue or red cars, the gaming system may change a red car to a blue car when the bet amount per line increases. The effect of this is to increase the probability of occurrence of a win outcome based on blue cars and to reduce the probability of a win outcome based on red cars. In this scenario, assuming that blue cars is associated with a special relatively high prize amount and red cars is associated with a relatively low prize amount, in order to maintain the Mean Prize Value for red cars at least at a value equal to the Mean Prize Value associated with a minimum bet amount, the gaming system may be arranged to increase the prize amount associated with a red cars win outcome.

It will be appreciated that in addition to win outcomes which are based on symbols of a particular colour, in this example red cars or blue cars, the gaming system may be arranged such that win outcomes may be based on occurrence of symbols, in this example cars, of any colour.

It will also be appreciated that other arrangements for increasing the probability of particular win outcomes are envisaged. For example, the special symbols may comprise one set of identical and similar special symbols and other non-special symbols may be changed to special symbols as required.

The location and number of symbols to be changed in order to modify the probability of a particular win outcome may be selected in any appropriate way. For example, the gaming system may use a formula to calculate the required probabilities for occurrence of symbols on each reel based on desired win outcome probabilities, and may change the number of symbols on one or more reels based on the determined symbol probabilities.

This may be achieved by specifying desired outcome probabilities associated with symbols, specifying a desired relationship between the number or probability of symbols on a plurality of reels, and calculating the symbol probabilities on each reel using the relationship and the specified outcome probabilities.

For example, in an example gaming system which includes 5 reels, each of which includes at least one star symbol. Win outcomes including 3, 4 or 5 star symbols in a line left to right constitute a jackpot prize which would exceed the maximum permissible prize amount if the bet amount is greater than the minimum bet amount. Accordingly, it is necessary to increase the win outcome probabilities for 3, 4 or 5 stars when the bet amount exceeds the minimum bet amount.

In this example, assume that the following win outcome probabilities are specified:

The probability of 3 stars left to right is A;

The probability of 4 stars left to right is B; and

The probability of 5 stars left to right is C.

The probability of occurrence of a star symbol on reels 1, 2, 3, 4 and 5 is defined as u, v, w, x and y respectively.

It follows that:
A=uvw(1−x)
B=uvwx(1−y)
C=uvwxy
and that:
uvwx=B+C
uvw=A+B+C

If u, v and w are specified to have a relationship such that u, v and w are the same, then:
u=v=w=(A+B+C)^{1/3} (1)
x=(B+C)/(A+B+C) (2)
y=C/(B+C) (3)

Accordingly, the probability u, v, w, x, y of occurrence of a star for each reel can be expressed in terms of the desired win outcome probabilities for 3, 4 or 5 stars. Therefore, assuming that the bet is b, the desired win outcome probabilities can be expressed as bA, bB and bC, and the required symbol probabilities u, v and w can be determined by solving equation (1) for bA, bB and bC. The symbol probabilities x and y will remain the same irrespective of the bet b.

Once u is known, the number of star symbols on each of the first 3 reels can be simply modified to fit the calculated symbol probability u, v, w on each reel.

It will be understood that the formula may be modified to take into consideration special pay patterns, special symbol layouts on reels such as stacked symbols, different denominations, line or way bets, start up and increment values for progressive values, “wild” symbols, “scatter” symbols, free games, repeat win games, multiplier features, different numbers of reels and different numbers of visible symbols.

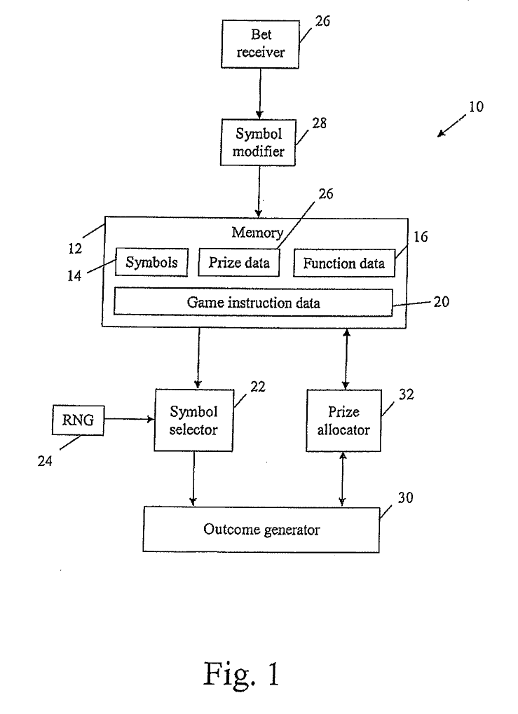

Referring to FIG. 1, a gaming system 10 is shown in diagrammatic form. The gaming system 10 comprises a memory 12 arranged to store symbols data 14 indicative of a plurality of symbols for selection and display to a player during a game, function data 16 indicative of one or more functions associated with at least one of the symbols, prize data 18 indicative of prize amounts associated with win outcomes, and game instruction data 20 indicative of game instructions usable by the gaming machine 10 to control operation of the game.

The gaming system 10 also includes a symbol selector 22 which is arranged to select several symbols for display to a player, in this example using a random number generator 24.

It will be appreciated that the random number generator 24 may be of a type which is arranged to generate pseudo random numbers based on a seed number, and that in this specification the term “random” will be understood accordingly to mean truly random or pseudo random.

The gaming system 10 also comprises a bet receiver 26 arranged to receive a bet amount from a player and a symbol modifier 28 arranged to modify the stored symbols 14 based on the bet received so that the Mean Prize Value associated with one or more win outcomes having relatively high prize amounts is maintained at a value at least equal to a corresponding Mean Prize Value associated with a minimum bet amount.

The gaming system 10 also comprises an outcome generator 30 which in accordance with the game instructions 18 determines game outcomes based on the symbols selected for display to a player by the symbol selector 22, in particular whether a displayed combination of symbols corresponds to one or more win outcomes.

The gaming system 10 also comprises a prize allocator 32 which communicates with the prize data 18 stored in the memory 12 and the outcome generator 30, and determines an appropriate prize to allocate to a win outcome. For example, in the present embodiment, if the bet received per line is greater than the minimum bet amount per line and a multiple of the prize amount would be less than the maximum permissible win amount, the prize allocator 32 is arranged to multiply the relevant prize amount stored in the memory 12 so as to maintain the Mean Prize Value at least at a value equal to the Mean Prize Value associated with a minimum bet amount per line.

In the embodiment described below, the symbol selector 22, the bet receiver 26, the symbol modifier 28, the prize allocator 32 and the outcome generator 30 are implemented using a microprocessor and associated programs, although it will be understood that other implementations are envisaged.

The gaming system 10 can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

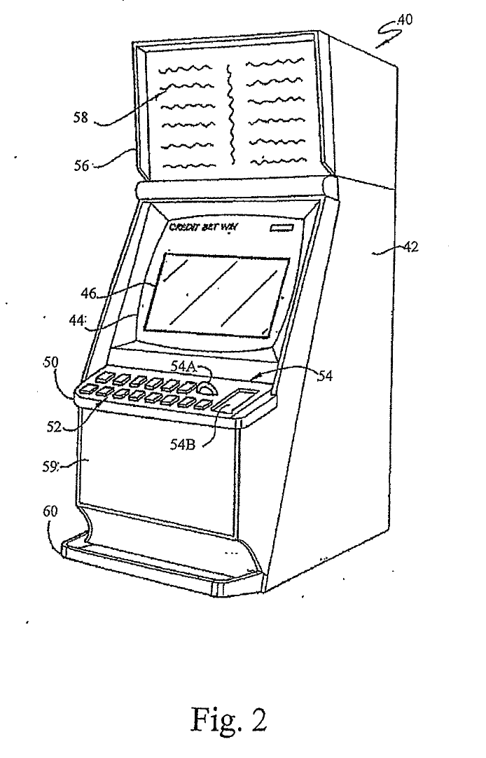

A gaming system in the form of a stand alone gaming machine 40 is illustrated in FIG. 2. The gaming machine 40 includes a console 42 having a display 44 on which is displayed representations of a game 46 that can be played by a player. A mid-trim 50 of the gaming machine 40 houses a bank of buttons 52 for enabling a player to interact with the gaming machine during gameplay, including enabling the player to select the bet amount and the number of lines. The mid-trim 50 also houses a credit input mechanism 54 which in this example includes a coin input chute 54A and a bill collector 54B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 56 may carry artwork 58, including for example pay tables and details of bonus awards and other information or images relating to the game. Further artwork and/or information may be provided on a front panel 59 of the console 42. A coin tray 60 is mounted beneath the front panel 59 for dispensing cash payouts from the gaming machine 30.

The display 44 is in the form of a video display unit, particularly a cathode ray tube screen device. Alternatively, the display 44 may be a liquid crystal display, plasma screen, any other suitable video display unit. The top box 56 may also include a display, for example a video display unit, which may be of the same type as the display 44, or of a different type.

The display 44 in this example is arranged to display representations of several reels, each reel of which has several associated symbols. Typically 3, 4 or 5 reels are provided. During operation of the game, the reels first appear to rotate then stop with typically three symbols visible on each reel. Game outcomes are determined on the basis of the visible symbols together with any special functions associated with the symbols.

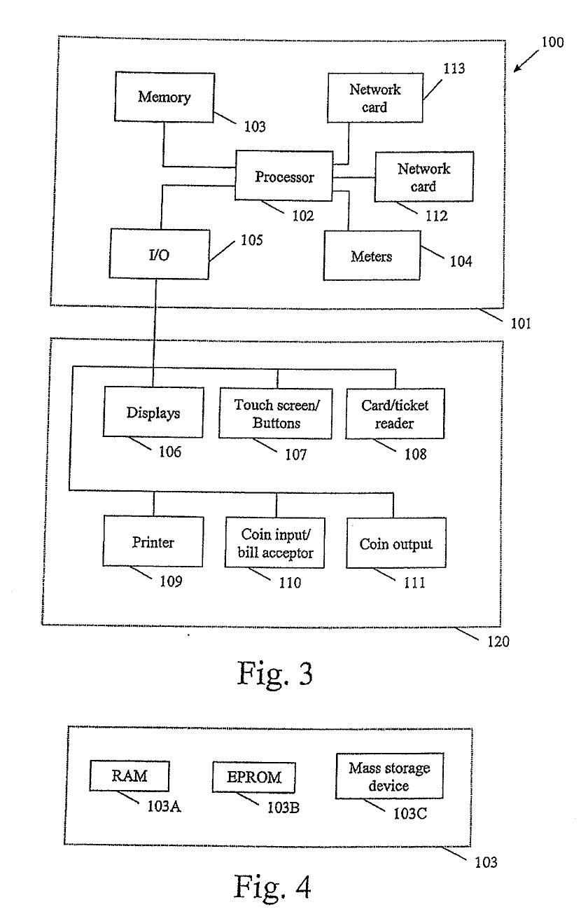

FIG. 3 shows a block diagram of operative components of a typical gaming machine 100 which may be the same as or different to the gaming machine shown in FIG. 2.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere, and data indicative of symbols, prize amounts and symbol functions used in the game.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 3, the peripheral devices that communicate with the game controller 101 comprise one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106,107,108,109,110,111 may be provided remotely from the game controller 101.

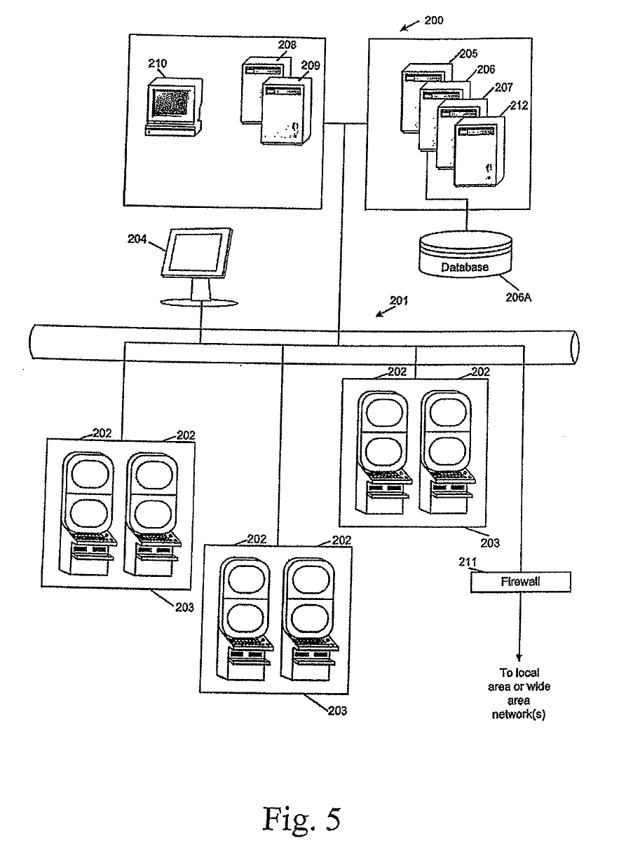

FIG. 5 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

During operation, the game controller, whether implemented in a stand alone gaming machine 10, 100 or over a network 201, implements a probabilistic wagering game wherein for all win outcomes irrespective of the prize amount and magnitude of bet received, the Mean Prize Value is always greater than or equal to a Mean Prize Value associated with a minimum bet amount.

An example of a specific implementation of the gaming system will now be described in relation to a stand alone gaming machine 10, 10, although it will be understood that implementation may also be carried out using other gaming system architectures such as a network architecture of the type shown in FIG. 5.

In the present embodiment, the gaming system 10 comprises virtual reels implemented using a video graphical display device.

Win outcomes are determined on the basis of the symbols visible when the reels stop rotating, and in this example five reels are provided, each reel has 20 symbols, and three symbols are displayed on each reel at any time.

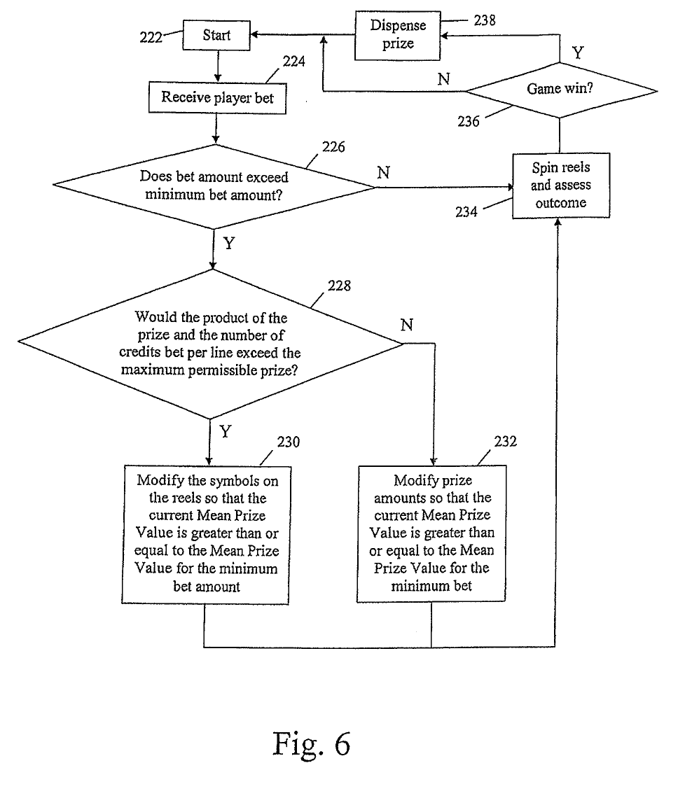

Referring to FIG. 6, there is shown a flow diagram 220 shown which illustrates steps 222 to 238 of a method of gaming implemented by the gaming system 10 according to the present embodiment.

In this example, the player can bet in respect of 1 to 3 lines per game corresponding to a top generally horizontal visible line, a middle generally horizontal visible line and a bottom generally horizontal visible line. The player can also bet up to five credits per line with the minimum bet being one credit per line.

A win outcome is determined to exist when a predetermined combination of symbols appears along a line in respect of which a bet has been placed. For example, if a bet is placed in respect of a particular line, a win outcome may correspond to two Aces appearing in the line, two Kings and a wild symbol appearing in the line or scattered special symbols distributed across three lines.

For win outcomes which correspond to relatively low win amounts, an increase in the bet amount per line causes an increase in the prize amount sufficient to maintain the Mean Prize Value at an amount at least equal to the Mean Prize Value associated with a minimum bet per line. This occurs if multiplication of the prize amount would result in a prize amount which is less than the maximum permissible prize amount.

For example, if a game produces the following outcome:

| | | | | |
|---|---|---|---|---|
| Queen | Cat | Jack | Ace | Ten |
| Cat | Jack | Queen | King | Nine |
| Ace | Ace | Cat | Ten | King |

prizes may be payable for scattered cats across three lines and two Aces in the bottom line.

For a minimum bet of 1 credit per line, the prize amount for scattered cats in this example is 6 credits, which is calculated as follows:
Prize amount=(number of lines)*(credits bet per line)*(prize for scattered cats)=3*1*2=6

Using the above formula, for a bet of 5 credits per line, the prize amount for scattered cats would be 30 credits.

It will be appreciated that since with this example the prize amount increases in proportion to the increase in the bet amount, the Mean Prize Value will remain the same, and in this way the gaming system ensures that a player is not disadvantaged by increasing the bet.

If each reel has 20 symbols including 1 black dog and 6 white dogs, the probability of 5 black dogs appearing in a particular line is 1/3,200,000. The prize for 5 black dogs in a particular line is a car valued at $32,000. If the player bets 1 credit for 1 line and the value of a credit is 1$, then the Mean Prize Value to the player for this win outcome is:
Mean Prize Value=32,000/3,200,000=1%

If the player bets 3 lines and 1 credit per line, the amount bet has increased by 3 and the probability of a win outcome has also increased by 3. The Mean Prize Value therefore remains at 1%.

If the player bets 1 line and 5 credits per line, without modification of the probability, the Mean Prize Value is:
Mean Prize Value=32,000/(5*320,000)=0.2%

With this scenario, it is not possible to increase the prize amount because the maximum permissible prize amount would be exceeded, and the effect of increasing the bet amount is that the Mean Prize Value has reduced.

With the gaming system in accordance with the present invention, if the player increases the bet amount per line, the number of black dogs on the first reel increases in number according to the increase in bet amount. For example, if the player bets 2 credits per line, the gaming system modifies the symbols 14 stored in the memory 12 so as to increase the number of black dogs in the first reel to 2. As a consequence, the Mean Prize Value for a win combination corresponding to 5 black dogs in a particular line is:
MPV=Prize amount (32,000)/([Bet per line (2)]/[Win probability (2/3,200,000)])=1%
where MPV is the Mean Prize Value.

It will be appreciated that with this example although the prize amount stays the same, the win probability increases as the bet amount increases and the Mean Prize Value for a win outcome including 5 black dogs in a line remains the same. In this way, the gaming system ensures that a player is not disadvantaged by increasing the bet.

It will be understood that since the number of white dogs present in the first reel has reduced, the probability of a win outcome including 5 white dogs has also reduced. In order to avoid a reduction in the mean Prize Value for a win outcome including 5 white dogs, the prize amount associated with this win outcome is increased by an amount sufficient to maintain the Mean Prize Value at least at a level equal to the Mean Prize Value associated with a minimum bet amount. This is possible because significantly more white dogs are present on the reels, and a much lower prize amount will therefore be allocated to win outcomes including white dogs than win outcomes including black dogs. Increasing the white dogs prize amount will therefore still be less than the maximum permissible prize amount.

It will be appreciated that with the above example it is relatively simple to determine the symbol(s) to modify in order to maintain required Mean Prize Values at required levels because only one black dog is originally present on each reel. However, with different numbers of black dogs on one or more of the reels, determination of the required symbols to modify becomes more complex. While this can be achieved by trial and error, the inventor has devised a method of determining the required symbols to modify by establishing a relationship between the win outcome frequency, which relates to the win outcome probability, and the probability of occurrence of symbols on a reel, which relates to the number of symbols on the reel. As discussed above, this is achieved by specifying desired outcome probabilities associated with symbols, specifying a desired relationship between the number or probability of symbols on a plurality of reels, and calculating the symbol probabilities on each reel using the relationship and the specified outcome probabilities.

It will be appreciated that certain embodiments of the present invention enable wagering game operators to offer special relatively large prize amounts, whilst still multiplying prize amounts for relatively small prize amounts, maintaining required Mean Prize Values at required levels, and maintaining the prize amounts below a maximum permissible prize amount required in some jurisdictions.

In the claims of this application and in the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

Modifications and variations as would be apparent to a skilled addressee are deemed to be within the scope of the present invention.

The claims defining the invention are as follows:

1. A gaming system comprising:
a bet receiver arranged to receive a bet amount from a player;
a symbol modifier arranged to modify at least one symbol in a set of symbols when the bet amount is greater than a minimum bet amount so as to increase the probability of occurrence of a symbol win combination and thereby maintain the Mean Prize Value for the symbol win combination greater than or equal to a predetermined minimum Mean Prize Value;
a symbol selector arranged to randomly select a plurality of symbols from the set of symbols for display to a player;
a game outcome generator arranged to determine a game outcome based on the selected symbols; and,
a prize allocator arranged to allocate a prize amount to the player based on the determined game outcome.

2. A gaming system as claimed in claim 1, wherein the symbol modifier is arranged to modify at least one symbol in the set of symbols when the bet amount is greater than a minimum bet amount if increasing the prize amount sufficiently to increase the Mean Prize Value to a value greater than or equal to a predetermined minimum Mean Prize Value would produce a prize amount which exceeds a maximum permissible prize amount.

3. A gaming system as claimed in claim 1, wherein the set of symbols comprises a set of special symbols comprising a first set of first special symbols and a second set of second special symbols, the first and second sets of symbols sharing a common property and including a distinguishable different property, the symbol modifier being arranged to replace at least one second symbol with at least one respective first symbol when the bet amount is above the minimum bet amount in order to maintain the Mean Prize Value associated with a win outcome including the first set of symbols greater than or equal to a predetermined minimum Mean Prize Value.

4. A gaming system as claimed in claim 3, wherein the common property is a symbol type and the distinguishable property is symbol colour.

5. A gaming system as claimed in claim 3, wherein the game outcome generator is arranged such that a win outcome occurs based on a combination of the first and second sets of symbols.

6. A gaming system as claimed in claim 3, wherein the set of special symbols comprises a relatively low number of first special symbols and a relatively high number of second special symbols, and the prize allocator is arranged to allocate a relatively high prize amount to a win symbol combination including the first set of special symbols and a relatively low prize amount to a win symbol combination including the second set of special symbols.

7. A gaming system as claimed in claim 1, wherein the system is arranged to increase the prize amount associated with a symbol win combination so that the Mean Prize Value for the win symbol combination is greater than or equal to a predetermined minimum Mean Prize Value when the bet amount is greater than the minimum bet amount if increasing the prize amount sufficiently to increase the Mean Prize Value to a value greater than or equal to a predetermined minimum Mean Prize Value would not produce a prize amount which exceeds a maximum permissible prize amount.

8. A gaming system as claimed in claim 1, wherein the gaming system is arranged to apply a formula to calculate the required probabilities for occurrence of symbols on each reel based on the desired win outcome probability, and to modify the number of symbols on one or more reels based on the calculated probabilities.

9. A gaming system as claimed in claim 8, wherein the formula is derived by specifying desired outcome probabilities associated with symbol win combinations, specifying a relationship between the respective probabilities of symbols occurring on a plurality of reels, and calculating the probability of a symbol occurring on each reel using the relationship and the specified outcome probabilities.

10. A gaming system as claimed in claim 9, wherein the relationship between the probability of symbols occurring on a plurality of reels is that the probability of a symbol occurring on each reel of a plurality of reels is the same.

11. A gaming system as claimed in claim 10, wherein the gaming system comprises 5 reels and the formula for calculating the required probabilities for occurrence of symbols on each reel is:
u=v=w=(nA+nB+nC)^{1/3} (1)
x=(B+C)/(A+B+C) (2)
y=C/(B+C) (3)
where u, v, w, x and y are the probabilities of occurrence of a symbol on reels 1, 2, 3, 4 and 5 respectively; n is the number of credits bet; and A, B and C are desired outcome probabilities for win outcomes associated with predetermined combinations of symbols.

12. A gaming system as claimed in claim 1, wherein the gaming system is implemented as a stand alone gaming machine or across a network.

13. A method of gaming comprising:
providing a set of symbols
receiving a bet amount from a player;
modifying at least one symbol in a set of symbols when the bet amount is greater than a minimum bet amount so as to increase the probability of occurrence of a symbol win combination and thereby maintain the Mean Prize Value for the symbol win combination greater than or equal to a predetermined minimum Mean Prize Value;
randomly selecting a plurality of symbols from the set of symbols for display to a player;
determining a game outcome based on the selected symbols; and
allocating a prize amount to the player based on the determined game outcome.

14. A method as claimed in claim 13, further comprising modifying at least one symbol in the set of symbols when the bet amount is greater than a minimum bet amount if increasing the prize amount sufficiently to increase the Mean Prize Value to a value greater than or equal to a predetermined minimum Mean Prize Value would produce a prize amount which exceeds a maximum permissible prize amount.

15. A method as claimed in claim 13, wherein the set of symbols comprises a set of special symbols comprising a first set of first special symbols and a second set of second special symbols, the first and second sets of symbols sharing a common property and including a distinguishable different property, the method further comprising replacing at least one second symbol with at least one respective first symbol when the bet amount is above the minimum bet amount in order to maintain the Mean Prize Value associated with a win outcome including the first set of symbols greater than or equal to a predetermined minimum Mean Prize Value.

16. A method as claimed in claim 15, wherein the common property is a symbol type and the distinguishable property is symbol colour.

17. A method as claimed in claim 15, further comprising defining a win outcome occurs based on a combination of the first and second sets of symbols.

18. A method as claimed in claim 15, wherein the set of special symbols comprises a relatively low number of first special symbols and a relatively high number of second special symbols, and method further comprises allocating a relatively high prize amount to a win symbol combination including the first set of special symbols and a relatively low prize amount to a win symbol combination including the second set of special symbols.

19. A method as claimed in claim 13, comprising increasing the prize amount associated with a symbol win combination so that the Mean Prize Value for the win symbol combination is greater than or equal to a predetermined minimum Mean Prize Value when the bet amount is greater than the minimum bet amount if increasing the prize amount sufficiently to increase the Mean Prize Value to a value greater than or equal to a predetermined minimum Mean Prize Value would not produce a prize amount which exceeds a maximum permissible prize amount.

20. A method as claimed in claim 13, comprising applying a formula to calculate the required probabilities for occurrence of symbols on each reel based on the desired win outcome probability, and modifying the number of symbols on one or more reels based on the calculated probabilities.

21. A method as claimed in claim 20, comprising deriving the formula by specifying desired outcome probabilities associated with symbol win combinations, specifying a relationship between the respective probabilities of symbols occurring on a plurality of reels, and calculating the probability of a symbol occurring on each reel using the relationship and the specified outcome probabilities.

22. A method as claimed in claim 21, comprising specifying that the relationship between the probability of symbols occurring on a plurality of reels is that the probability of a symbol occurring on each reel of a plurality of reels is the same.

23. A method as claimed in claim 22, comprising providing 5 reels and wherein the formula for calculating the required probabilities for occurrence of symbols on each reel is:
u=v=w=(nA+nB+nC)^{1/3} (1)
x=(B+C)/(A+B+C) (2)
y=C/(B+C) (3)
where u, v, w, x and y are the probabilities of occurrence of a symbol on reels 1, 2, 3, 4 and 5 respectively; n is the number of credits bet; and A, B and C are desired outcome probabilities for win outcomes associated with predetermined combinations of symbols.

24. A computer program arranged when loaded into a computer to instruct the computer to operate in accordance with a gaming system as claimed in claim 1.

25. A computer usable medium having computer readable program code embodied therein for causing a computer to operate in accordance with a gaming system as claimed in claim 1.
